(19) United States
(12) Patent Application Publication
(10) Pub. No.: US 2019/0353088 A1
(43) Pub. Date: Nov. 21, 2019

(54) VARIABLE VOLUME PRE-CHAMBER FOR A COMBUSTION ENGINE

(71) Applicant: GM Global Technology Operations LLC, Detroit, MI (US)

(72) Inventor: Justin E. Ketterer, LaSalle, CA (US)

(21) Appl. No.: 15/979,926

(22) Filed: May 15, 2018

(51) Int. Cl. F02B 19/10

(52) U.S. Cl. CPC F02B 19/1014; F02B 19/108

(57) ABSTRACT

A pre-chamber for varying the compression ratio of an internal combustion engine includes a cylinder with an internal volume, a piston that moves within the cylinder to vary the volume of the internal volume of the cylinder, a spark plug, and a nozzle. The pre-chamber nozzle is in fluid communication with a primary cylinder of the internal combustion engine.

### INTRODUCTION

The present disclosure relates to internal combustion engines with variable compression ratios. More specifically, the present disclosure relates to a pre-chamber for varying compression ratios of internal combustion engines.

In certain internal combustion engines, the compression ratio is varied to optimize the performance of the engine. For example, a high compression ratio is utilized for lighter loads in which knock is not a primary concern. Whereas for high-load, knock limited conditions a lower compression ratio is utilized.

Typically, to vary the compression ratio the piston height was varied, which effectively changes the combustion chamber volume at top-dead-center. Such strategies, however, tend to compromise the flame propagation in the combustion chamber after the fuel-air mixture is ignited.

Thus, while current approaches achieve their intended purpose, there is a need for a new and improved system to vary the compression ratio of internal combustion engines.

### SUMMARY

According to several aspects, a pre-chamber for varying the compression ratio of an internal combustion engine includes a cylinder with an internal volume, a piston that moves within the cylinder to vary the volume of the internal volume of the cylinder, a spark plug, and a nozzle. The pre-chamber nozzle is in fluid communication with a primary cylinder of the internal combustion engine.

In an additional aspect of the present disclosure, the pre-chamber further includes a fuel injector that injects fuel into the pre-chamber cylinder, the spark plug igniting a fuel-air mixture in the cylinder.

In another aspect of the present disclosure, the primary cylinder further includes a second fuel injector that injects fuel into the primary cylinder.

In another aspect of the present disclosure, an intake port includes a second fuel injector that injects fuel into the intake port in fluid communication with the primary cylinder.

In another aspect of the present disclosure, the piston is positioned within the cylinder to reduce the volume in the cylinder for high compression ratio operation.

In another aspect of the present disclosure, the piston is positioned within the cylinder to expand the volume in the cylinder for low compression ratio operation.

In another aspect of the present disclosure, the volume in the cylinder is continuously variable.

In another aspect of the present disclosure, the volume in the cylinder is step variable.

In another aspect of the present disclosure, the nozzle is made of the same material as the pre-chamber cylinder.

In another aspect of the present disclosure, the nozzle is an insert made of a different material than the pre-chamber cylinder, the insert being made of a low heat-loss material.

According to several aspects, a pre-chamber for varying the compression ratio of an internal combustion engine includes a cylinder with an internal volume, a piston that moves within the cylinder to vary the volume of the internal volume of the cylinder, a spark plug, a fuel injector that injects fuel into the cylinder, the spark plug igniting a fuel-air mixture in the cylinder, and a nozzle. The pre-chamber nozzle is in fluid communication with a primary cylinder of the internal combustion engine.

In another aspect of the present disclosure, the primary cylinder further includes a second fuel injector that injects fuel into the primary cylinder.

In another aspect of the present disclosure, an intake port includes a second fuel injector that injects fuel into the intake port in fluid communication with the primary cylinder.

In another aspect of the present disclosure, the piston is positioned within the cylinder to reduce the volume in the cylinder for high compression ratio operation.

In another aspect of the present disclosure, the piston is positioned within the cylinder to expand the volume in the cylinder for low compression ratio operation.

In another aspect of the present disclosure, the volume in the cylinder is continuously variable.

In another aspect of the present disclosure, the volume in the cylinder is step variable.

According to several aspects, a pre-chamber for varying the compression ratio of an internal combustion engine includes a cylinder with an internal volume, a piston that moves within the cylinder to vary the volume of the internal volume of the cylinder, a fuel injector that injects fuel into a primary cylinder of the internal combustion engine and/or to an intake port in fluid communication with the primary cylinder, a spark plug and a nozzle. The pre-chamber nozzle is in fluid communication with a primary cylinder of the internal combustion engine. The spark plug ignites the mixture in the pre-chamber, with the jet of hot combustion gasses passing through the nozzle igniting the remaining fuel-air mixture in the primary cylinder.

In an additional aspect of the present disclosure, the piston is positioned within the cylinder to reduce the volume in the cylinder for high compression ratio operation.

In another aspect of the present disclosure, the piston is positioned within the cylinder to expand the volume in the cylinder for low compression ratio operation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cut-away view of a pre-chamber for varying the compression ratio of an internal combustion engine in accordance with the principles of the present disclosure;

FIG. 2A is a cut-away view of the pre-chamber shown in FIG. 1 for high compression ratio operation;

FIG. 2B is a cut-away view of the pre-chamber shown in in FIG. 1 for low compression ratio operation;

FIG. 3 is a cut-away view of a pre-chamber for varying the compression ratio of an internal combustion engine with intake port injection in accordance with the principles of the present disclosure;

FIG. 4 is a cut-away view of another pre-chamber for varying the compression ratio of an internal combustion engine in accordance with the principles of the present disclosure; and

FIG. 5 is cut-way view of yet another pre-chamber for varying the compression ratio of an internal combustion engine in accordance with the principles of the present disclosure.

### DETAILED DESCRIPTION

The following description is merely exemplary in nature and is not intended to limit the present disclosure, application, or uses.

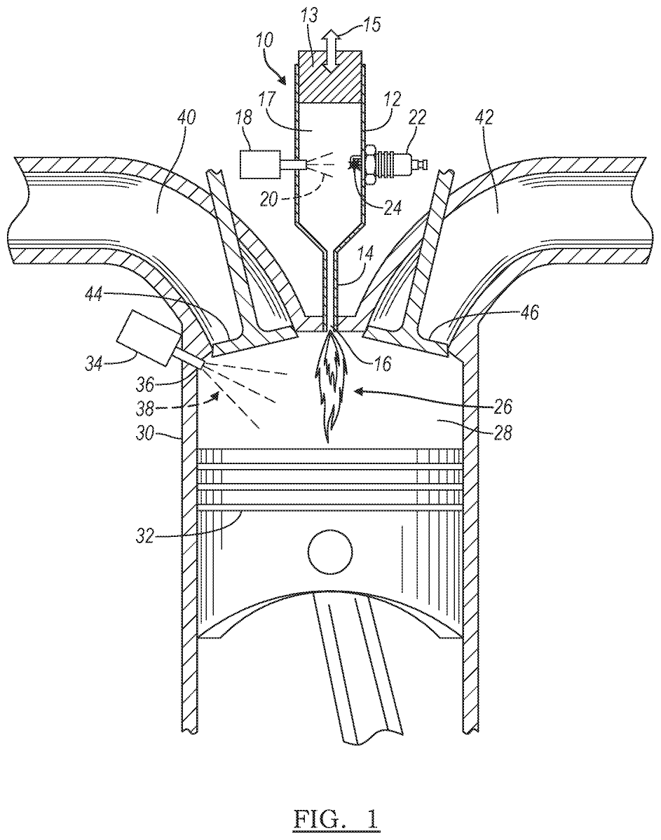

Referring to FIG. 1, there is shown a pre-chamber 10 for varying the compression ratio of an internal combustion engine. The pre-chamber 10 includes a cylinder 12 with an internal volume 17 and a piston 13 that is moveable within the cylinder 12 as indicated by the double arrow 15. The pre-chamber 10 further includes a nozzle 14 with an opening 16 that communicates with an interior volume or main chamber 28 of a cylinder 30, a fuel injector 18 that spays fuel 20 into the cylinder 12, and an igniter such as a spark plug 22 that creates a spark 24 to ignite the fuel air mixture in the cylinder 12. Other types of the igniter 22 utilized in various configurations of the pre-chamber 10 include, but are not limited to, plasma igniter, corona igniter, laser igniter, and microwave igniter.

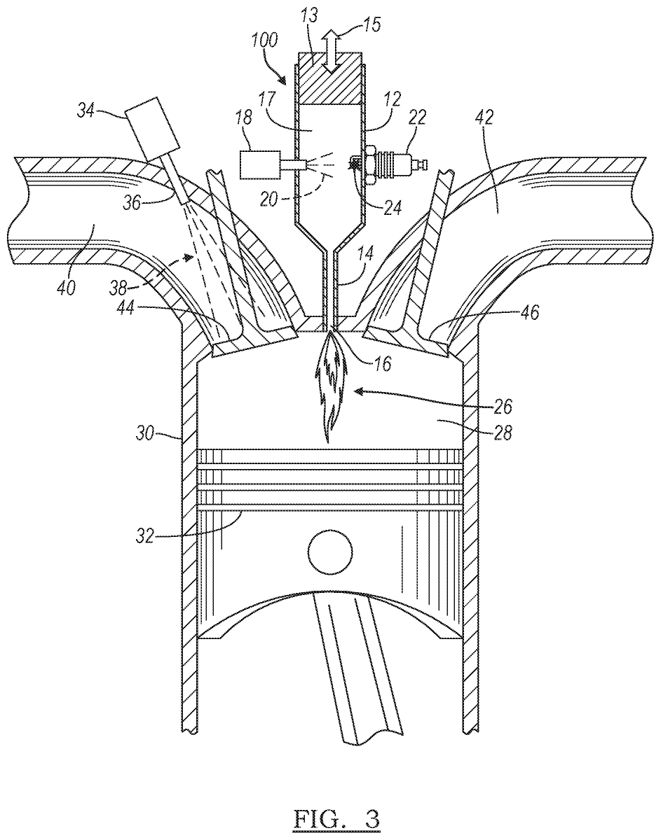

Housed within the cylinder 30 is a piston 32 that reciprocates within the cylinder 30. An intake port 40 provides air into the main chamber 28 when an intake valve 44 opens as the piston 32 moves downward, and an exhaust port 42 allows combustion products to leave the main chamber 28 when an exhaust valve 46 opens and the piston 32 moves upward. In certain configurations, a second fuel injector 34 with a nozzle 36 provides direct injection of fuel into the main chamber 28. In other configurations, as shown as a pre-chamber 100 in FIG. 3, the second fuel injector 34 provides port injection of the fuel spray 38 into the intake port 40.

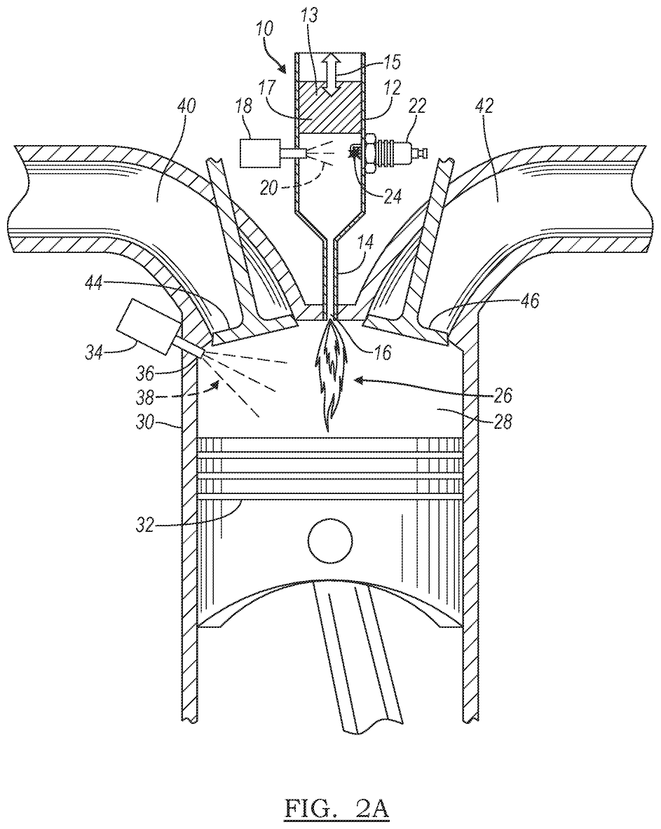

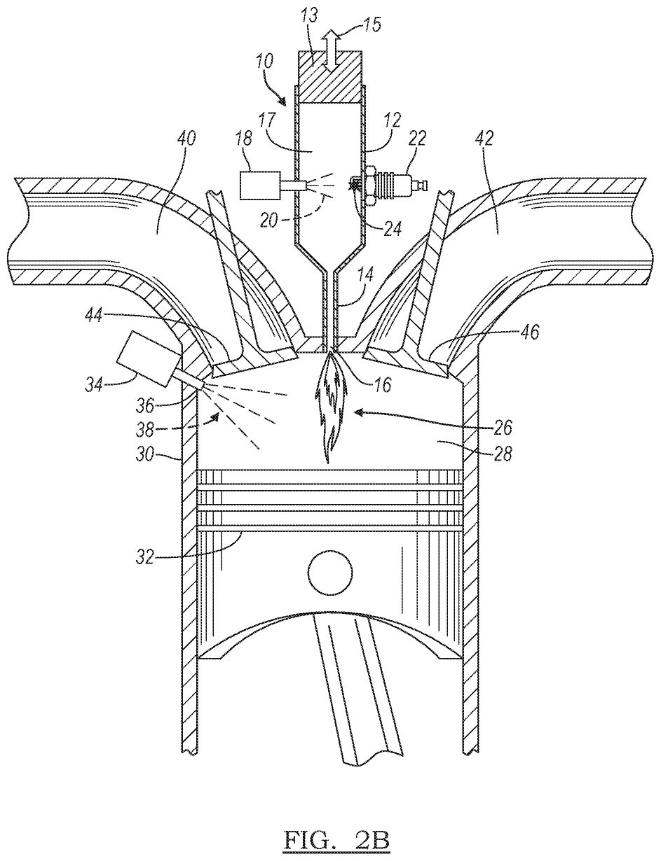

The sliding of the piston 13 allows the pre-chamber volume 17 to vary. For example, as shown in FIG. 2A, the piston 13 is moved towards the nozzle 14 to reduce the volume 17 within the cylinder 12 for high compression ratio operation, which is the appropriate mode for light to moderate loads. The high compression ratio (and equal expansion ratio) results in increased fuel efficiency as compared to a traditional combustion engine. For low compression ratio operation, as shown in FIG. 2B, the piston 13 is moved away from the nozzle 14 to increase the volume 17 within the cylinder 12, which is the appropriate mode for high-load knock-limited conditions. The low compression ratio limits knock, allowing fuel efficiency improvement through reduced ignition retard.

The configurations described above, as well as those described below, provide improved combustion stability and dilution tolerance, enabling dilute or lean/stratified combustion strategies. Accordingly, the sliding piston 13 allows the volume of the pre-chamber 10 to be varied, which varies the compression ratio of the entire system including the cylinder 30. Depending on the actuator, the volume is continuously variable or variable in discrete steps. Note that changing the volume results in no change to the main chamber 28 geometry, which minimizes any detrimental effects on the flame propagation in the main chamber 28. The types of mechanisms utilized to actuate the piston 13 include, but are not limited to, cam-driven, screw-driven, direct acting solenoid-driven, rocker arm solenoid-driven, hydraulically actuated, and gear driven actuators.

The direct injection configuration shown in FIG. 1 enables stratified combustion. A small amount of fuel 20 injected into the cylinder 12 results in a rich fuel-air mixture, which ignites readily with the spark plug 22. The main chamber 28 can then utilize a lean mixture with either the direct injector 34 shown in FIGS. 1, 2A and 2B or the port injector 34 configuration shown in FIG. 3, limiting emissions and improving efficiency. If the mixture is lean enough, the low combustion temperatures result in low NO, emissions and reduced heat losses. The small mass of fuel allows for a low-flow, high pressure fuel system that provides good atomization of the fuel spray 20. The narrow passage of the nozzle 14 to the main chamber 28 results in a jet of turbulent combustion gasses 26 into the main chamber 28, resulting in robust ignition of the primary mixture in the main chamber 28. In various configurations, the nozzle 14 is made of the same material as the cylinder 12. In other configurations, the nozzle 14 is an insert made of a different low heat-loss material. In certain configurations, the nozzle 14 includes a heat-transfer reducing coating.

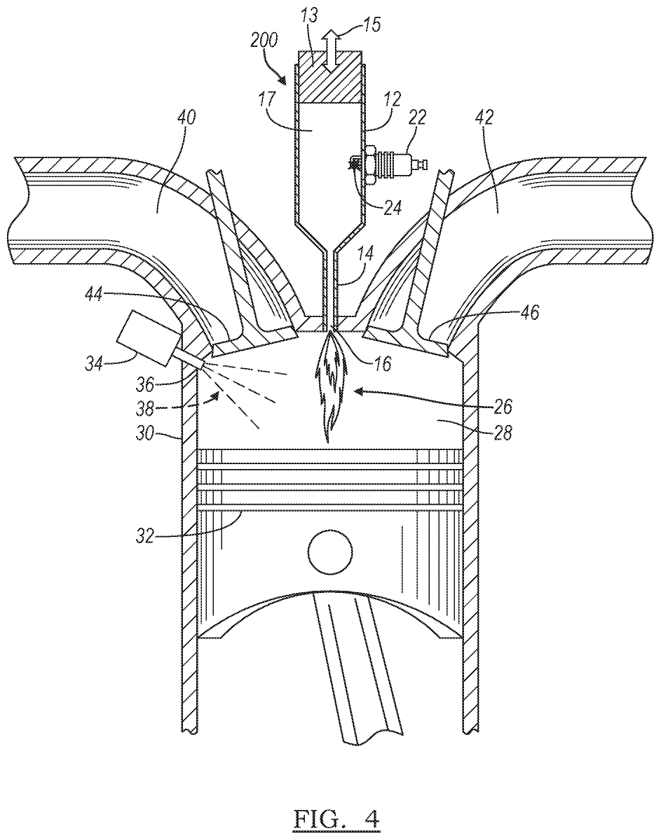

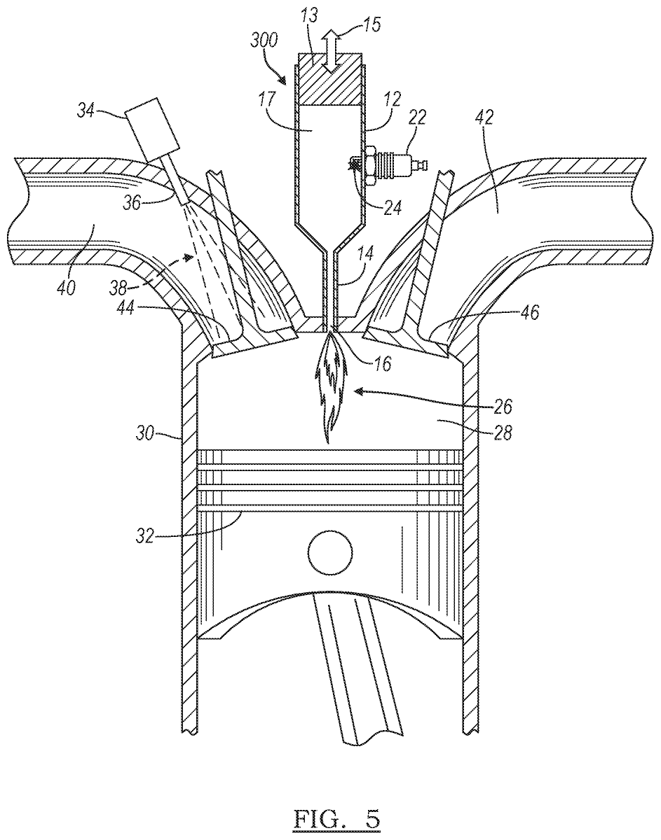

In certain arrangements of either the direct injection configuration shown in FIG. 1 or the port injection configuration shown in FIG. 3, the pre-chamber injector 18 is omitted, for example, as shown as a pre-chamber 200 (FIG. 4) and a pre-chamber 300 (FIG. 5). Such configurations still provide pre-chamber ignition and variable compression ratios, but provide homogeneous combustion rather than stratified combustion. Pre-chambers 200 and 300 would operate at stoichiometric conditions.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A pre-chamber for varying a compression ratio of an internal combustion engine comprising:
a cylinder with an internal volume;
a piston that moves within the cylinder to vary the volume of the internal volume of the cylinder;
a spark plug; and
a nozzle,
wherein the pre-chamber nozzle is in fluid communication with a primary cylinder of the internal combustion engine.

2. The pre-chamber of claim 1 further including a fuel injector that injects fuel into the pre-chamber cylinder, the spark plug igniting a fuel-air mixture in the pre-chamber cylinder.

3. The pre-chamber of claim 2 wherein the primary cylinder includes a second fuel injector that injects fuel into the primary cylinder.

4. The pre-chamber of claim 2 wherein an intake port includes a second fuel injector that injects fuel into the intake port in fluid communication with the primary cylinder.

5. The pre-chamber of claim 1 wherein the piston is positioned within the cylinder to reduce the volume in the cylinder for high compression ratio operation.

6. The pre-chamber of claim 1 wherein the piston is positioned within the cylinder to expand the volume in the cylinder for low compression ratio operation.

7. The pre-chamber of claim 1 wherein the volume in the cylinder is continuously variable.

8. The pre-chamber of claim 1 wherein the volume in the cylinder is step variable.

9. The pre-chamber of claim 1 wherein the nozzle is made of the same material as the pre-chamber cylinder.

10. The pre-chamber of claim 1 wherein the nozzle is an insert made of a different material than the pre-chamber cylinder, the insert being made of a low heat-loss material.

11. A pre-chamber for varying a compression ratio of an internal combustion engine comprising:
a cylinder with an internal volume;
a piston that moves within the cylinder to vary the volume of the internal volume of the cylinder;
a spark plug;
a fuel injector that injects fuel into the cylinder, the spark plug igniting a fuel-air mixture in the cylinder; and
a nozzle,
wherein the pre-chamber nozzle is in fluid communication with a primary cylinder of the internal combustion engine.

12. The pre-chamber of claim 11 further including a second fuel injector that injects fuel into the primary cylinder.

13. The pre-chamber of claim 11 wherein an intake port includes a second fuel injector that injects fuel into the intake port in fluid communication with the primary cylinder.

14. The pre-chamber of claim 11 wherein the piston is positioned within the cylinder to reduce the volume in the cylinder for high compression ratio operation.

15. The pre-chamber of claim 11 wherein the piston is positioned within the cylinder to expand the volume in the cylinder for low compression ratio operation.

16. The pre-chamber of claim 11 wherein the volume in the cylinder is continuously variable.

17. The pre-chamber of claim 11 wherein the volume in the cylinder is step variable.

18. A pre-chamber for varying a compression ratio of an internal combustion engine comprising:
a cylinder with an internal volume;
a piston that moves within the cylinder to vary the volume of the internal volume of the cylinder;
a spark plug;
a fuel injector that injects fuel into a primary cylinder of the internal combustion engine or into an intake port in fluid communication with the primary cylinder or both the primary cylinder and the intake port; and
a nozzle,
wherein the pre-chamber nozzle is in fluid communication with a primary cylinder of the internal combustion engine, the spark plug igniting a fuel-air mixture in pre-chamber cylinder, a jet of hot combustion gasses passing through the nozzle thereby igniting the remaining fuel-air mixture in the primary cylinder.

19. The pre-chamber of claim 18 wherein the piston is positioned within the cylinder to reduce the volume in the cylinder for high compression ratio operation.

20. The pre-chamber of claim 18 wherein the piston is positioned within the cylinder to expand the volume in the cylinder for low compression ratio operation.
